(19) United States
(12) Patent Application Publication
(10) Pub. No.: US 2026/0225031 A1
(43) Pub. Date: Aug. 6, 2026

(54) SYSTEM AND METHOD FOR CONVERTING CARBON DIOXIDE IN A GAS STREAM TO COMMERCIALLY DESIRABLE CHEMICAL PRODUCTS

(71) Applicant: Rushnu Inc, Pleasanton, CA (US)

(72) Inventors: Mohammad Martin Hanifzadeh, Pleasanton, CA (US); Jackson Faylor, Stockton, CA (US)

(73) Assignee: Rushnu Inc, Pleasanton, CA (US)

(21) Appl. No.: 19/153,330

(22) PCT Filed: Feb. 9, 2024
(86) PCT No.: PCT/US2024/015167

§ 371 Date: Aug. 3, 2025

Related U.S. Application Data
(60) Provisional application No. 63/484,194, filed on Feb. 10, 2023.

(51) Int. Cl. B01D 53/14; C01B 32/60; C01C 1/16

(52) U.S. Cl. CPC B01D 53/1475; B01D 53/1425; B01D 53/1493; C01B 32/60; C01C 1/164; B01D 2252/102; B01D 2257/2045; B01D 2257/504

(57) ABSTRACT

A system and method that is effective to reduce the amount of carbon dioxide contained in a gas stream. A carbon dioxide absorption and mineralization package is configured to create at least one of carbonates and bicarbonates, and ammonium chloride, from carbon dioxide in the gas stream, an ammoniated solvent, and at least one metal chloride. A mineral separation package is configured to separate carbonates and bicarbonates from the ammonium chloride. A solvent regeneration package is configured to use a catalyst in the creation of chlorine and ammonium hydroxide from the ammonium chloride, heat and oxygen.

### CROSS-REFERENCE TO RELATED APPLICATION

This application claims priority to Provisional Patent Application 63/484,194, filed on Feb. 10, 2023, the entire contents of which being incorporated herein by reference.

### BACKGROUND

This disclosure relates to systems and methods for the capture of carbon dioxide (CO₂) from diluted gas streams including but not limited to flue gas, and/or fermentation off-gas, and the use of the captured carbon dioxide to create minerals and other commercially desirable chemical products.

Carbon capture, utilization, and storage can help hard-to-abate sources achieve net-zero emissions. Two current approaches involve the capture of carbon before it is emitted into the atmosphere. These are commonly known as carbon capture and geological storage (CCS) and carbon capture and utilization (CCU), which have also been grouped into the term carbon capture utilization and storage (CCUS).

These methods rely on applying carbon capture technology in power plants or industrial processes before the carbon can be emitted. Capture technologies can be broadly separated into three types: (i) post-conversion capture, where the waste carbon dioxide is separated from a gas stream; (ii) pre-conversion capture, where the waste carbon dioxide has been produced as an undesired intermediate by-product that must be removed. In both pre- and post-conversion, carbon dioxide can be captured using various methods of absorption and adsorption, for instance absorption by chemical solvents or adsorption onto porous organic frameworks; and (iii) oxy-fuel combustion capture, where fuel is burned with pure oxygen, producing high purity carbon dioxide emissions free from nitrogen compounds.

Once captured, carbon dioxide is compressed and prepared for transportation before it is either stored or used. The most common storage location is within geological reservoirs. However, there are a series of challenges that must be addressed before CCS is considered to be the solution to the global crisis of excess carbon dioxide in the atmosphere, including the method of storage and the cost of injecting carbon dioxide into bedrock. One of the main economic barriers is that there are few financial incentives to sequester the gas, which has made developing and deploying CCS slow. However, carbon dioxide can be a versatile chemical feedstock for a variety of industries if captured and activated.

A viable alternative to storing carbon dioxide is to use the carbon as a so-called CO2 feedstock to create various useful chemical products. The advantage of utilization over conventional storage options is the financial incentives for industries to adopt these practices. By using carbon dioxide as a sustainable chemical feedstock, useful petrochemicals or commercial chemical products can be generated with the added advantage of removing and utilizing the vast reservoir of carbon dioxide.

But to be commercially viable, these processes need to be improved to yield a higher number of desirable products with less energy consumption and carbon footprint. As it becomes more difficult to source the environment's raw materials, recycling carbon dioxide into our chemicals will become a more attractive alternative for industry. Thus, innovative solutions to both capture CO2 and supply a chemical feedstock have significant environmental and economic value. The present disclosure relates to systems and methods for the capture and mineralization of carbon dioxide from diluted gas streams, to produce essential chemicals such as Cl2 (chlorine). Cl2, a major feedstock for many industrial applications (such as water treatment), is currently produced through chlor-alkali process that faces significant environmental challenges. Traditionally in the U.S., over 75% of chlor-alkali production used asbestos diaphragm-cell technology, exposing workers and the environment to harmful asbestos fibers. In contrast, Germany implemented regulations mandating the complete phase-out of asbestos in chlor-alkali production after 1994 due to health risks.

Another challenge is the energy intensity of chlor-alkali processes, especially those using the mercury-cell method. These processes are among the most energy-intensive in the chemical sector, consuming around 3,500 kWh per ton of chlorine produced. However, transitioning to membrane-cell technology could offer a significant reduction in energy consumption, by 15% or more per ton of product, thus presenting an important opportunity for energy savings.

Furthermore, the environmental impact of these processes is substantial. Historically, the mercury-cell process has led to mercury pollution, with older plants releasing significant amounts into the environment. Additionally, the chemical industry, including chlor-alkali production, is the third-largest industrial emitter of greenhouse gases due to its heavy reliance on fossil fuels.

These challenges highlight the urgent need for the chlor-alkali industry to embrace newer, safer, and more energy-efficient technologies.

### SUMMARY

All examples and features mentioned below can be combined in any technically possible way.

In an example this disclosure features a system and process for the capture and mineralization of CO2 from diluted gas streams. In an example there is an absorption and mineralization step where carbon dioxide from a CO2 enriched gas stream (such as flue gas or fermentation off-gas) reacts with a solvent. The solvent is composed of water, ammonium hydroxide, and a X-chloride salt where the cation X can be Ca²⁺, Mg⁺, Na⁺, or K⁺. In this process, CO2 is mineralized and produces solid X-carbonate and aqueous ammonium chloride. These combine to form an output stream which flows out of the absorber. The CO2 depleted gas then flows out and leaves the process entirely. After leaving the absorption and mineralization step the output stream enters a separation unit that removes the solid X-carbonate and ammonium chloride from the stream. The X-carbonate is then removed from the process while the ammonium chloride is sent to a regeneration process. In the regeneration process the ammonium chloride reacts with oxygen (which may be present in air) to remove the chlorine and release ammonium hydroxide. The newly produced ammonium hydroxide is then fed back to the absorber where it combines with fresh X-chloride.

The present disclosure describes systems and methods for the capture and mineralization of carbon dioxide (CO2) from diluted streams of CO2 including but not limited to, flue gas, and/or fermentation off-gas, to create commercially desirable products. The disclosed methods include the use of a high salinity solution and ammonia gas for CO2 capture and conversion to metal carbonate including CaCO₃, NaHCO₃, KHCO₃, or other similar carbonates or bicarbonates, and NH₄Cl. In some embodiments, the bicarbonates may be further processed and converted into carbonates. In some embodiments, NH₄Cl may be converted to NH₃ and HCl, such as by applying heat. In some alternate embodiments, NH₄Cl may be converted to NH₃ and NaCl, KCl, CaCl₂), or similar products by adding NaOH, KOH, Ca(OH)₂, or similar hydroxides.

In some embodiments, the disclosed methods use saline water (aqueous sodium chloride) and ammonia gas for the capture and conversion of CO2 to primary products including sodium carbonate (Na₂CO₃), HCl (or Cl₂), H₂O, and/or NH₄Cl. In some embodiments, the disclosed methods use aqueous potassium chloride and ammonia gas for the capture and conversion of CO₂ to primary products including potassium carbonate (K₂CO₃), HCl (or Cl₂), H₂O, and/or NH₄Cl.

In some embodiments, the disclosed methods use saline water (aqueous sodium chloride) and ammonia gas for the capture and conversion of CO2 to primary products including sodium bicarbonate (NaHCO₃), HCl (or Cl₂), H₂O, and/or NH₄Cl.

In some embodiments, the disclosed methods use aqueous potassium chloride and ammonia gas for the capture and conversion of CO2 to primary products including potassium bicarbonate (KHCO₃), HCl (or Cl₂), H₂O, and/or NH₄Cl.

In some embodiments, the disclosed methods use aqueous calcium chloride and ammonia gas for the capture and conversion of CO2 to primary products including calcium carbonate (CaCO₃), HCl (or Cl₂), H₂O, and/or NH₄Cl.

In some embodiments, sodium bicarbonate, potassium bicarbonate, calcium carbonate, or similar carbonates or bicarbonates generated using the disclosed methods are separated from aqueous ammonium chloride.

In some embodiments, sodium or potassium bicarbonate generated using the disclosed methods is heated and converted to sodium or potassium carbonate, respectively.

In some embodiments, ammonium chloride generated using the disclosed methods is converted into hydrochloric acid and ammonia. The resulting mixture of hydrochloric acid and ammonia gases can be separated, and the ammonia can then be recycled for reuse in the disclosed methods.

In some alternate embodiments, ammonium chloride is separated as a product for use as fertilizer or in fermentation processes, and the ammonia used in the disclosed methods is used as a precursor for the generation of ammonium chloride.

In one aspect, a system and method for reducing the amount of carbon dioxide contained in a gas stream includes a carbon dioxide absorption and mineralization package configured to create at least one of carbonates and bicarbonates, and ammonium chloride, from carbon dioxide in the gas stream, an ammoniated solvent, and at least one metal chloride, a mineral separation package configured to separate carbonates and bicarbonates from the ammonium chloride, and a solvent regeneration package configured to use a catalyst in the creation of chlorine and ammonium hydroxide from the ammonium chloride, heat and oxygen.

Some examples include one of the above and/or below features, or any combination thereof.

In some examples the solvent regeneration package is configured to separate HCl from an output of the mineral separation package by reacting HCl with a metal chloride-based catalyst X and oxygen to form XCl and water. In some examples the solvent regeneration package is configured to regenerate the catalyst X by decomposing XCl in the presence of a high temperature inert gas to generate Cl₂. In some examples the solvent regeneration package is configured to regenerate the catalyst X by reacting XCl with carbon monoxide to generate phosgene. In some examples the solvent regeneration package is configured to regenerate the catalyst X by reacting XCl with water to form HCl and oxygen.

Some examples include one of the above and/or below features, or any combination thereof. In some examples a molar ratio of ammonia to HCl in the solvent regeneration package is more than 1. In some examples the solvent regeneration package is configured to separate HCl from a gas stream by a membrane separation method. In some examples the system also includes a salt dissolver unit. In some examples the salt dissolver unit is configured to admix water and a salt to form a high salinity solution that is inputted to the carbon dioxide absorption and mineralization package. In some examples the high salinity solution is an aqueous solution of CaCl₂, MgCl₂, NaCl, KCl, or a mixture of two or more thereof. In some examples the salt dissolver unit is configured to admix seawater, brackish water, or wastewater and a salt to form a high salinity solution that is inputted to the carbon dioxide absorption and mineralization package. In some examples the high salinity solution is an aqueous solution of CaCl₂), MgCl₂, NaCl, KCl, or a mixture of two or more thereof.

Some examples include one of the above and/or below features, or any combination thereof. In an example the solvent regeneration package comprises an ammonia absorber configured to admix ammonia from the separator package with the high salinity solution to form an ammoniated high salinity solution, the carbon dioxide absorption and mineralization package is configured to admix the ammoniated high salinity solution from the ammonia absorber and a carbon dioxide containing gas stream to form aqueous ammonium chloride and carbonate and/or bicarbonate salts, the mineral separation package comprises a solid-liquid separator configured to separate at least a portion of the carbonate and/or bicarbonate salts from the aqueous ammonium chloride, wherein the carbonate and/or bicarbonate salts may be hydrated or anhydrous, and the solvent regeneration package further comprises a heater configured to vaporize water from the aqueous ammonium chloride and decompose ammonium chloride to form a mixture containing ammonia and HCl, and a water condenser configured to condense water vapor generated by use of the heater to generate liquid water.

Some examples include one of the above and/or below features, or any combination thereof. In some examples the solvent regeneration package comprises an ammonia absorber configured to admix ammonia with a brine solution to form ammoniated brine. In some examples the carbon dioxide absorption and mineralization package is configured to admix ammoniated brine and a carbon dioxide containing gas stream to form aqueous ammonium chloride and carbonate and/or bicarbonate salts. In some examples the mineral separation package comprises a solid-liquid separator configured to separate at least a portion of the carbonate and/or bicarbonate salts from the aqueous ammonium chloride, wherein the carbonate and/or bicarbonate salts may be hydrated or anhydrous. In some examples the system also includes a dryer configured to remove at least a portion of water from hydrated carbonate and/or bicarbonate salts that are separated in solid liquid separator. In some examples the solvent regeneration package further comprises a heater configured to vaporize water from the aqueous ammonium chloride and decompose ammonium chloride to form ammonia and HCl. In some examples the solvent regeneration package further comprises a water condenser configured to condense water vapor generated by use of the heater.

### BRIEF DESCRIPTION OF THE DRAWINGS

Various aspects of at least one example are discussed below with reference to the accompanying figures, which are not intended to be drawn to scale. The figures are included to provide illustration and a further understanding of the various aspects and examples and are incorporated in and constitute a part of this specification, but are not intended as a definition of the limits of the inventions. In the figures, identical or nearly identical components illustrated in various figures may be represented by a like reference character or numeral. For purposes of clarity, not every component may be labeled in every figure. In the figures:

FIG. 1 is a schematic representation of the general form of the system and process of the invention.

FIG. 2 is a more detailed schematic representation of a non-limiting example of a specific application of the system and process which utilizes calcium chloride to produce calcium carbonate (CaCO3) and chlorine gas (Cl2).

FIG. 3 shows the rate of conversion of CaCl2 to CaCO3 for flue gases with varying amounts of carbon dioxide.

FIG. 4 shows the rate of ammonia production for experiments run at different temperatures.

FIG. 5 shows the average and maximum rates of ammonia production achieved for experiments run as packed and fluidized bed reactions where all other parameters were the same.

FIG. 6 shows the amount of ammonia and hydrochloric acid dissolved in solution over time determined by ion chromatography.

FIG. 7 shows the average and maximum rates of chlorine production achieved for experiments run at different temperatures where all other parameters were the same.

FIG. 8 shows the average and maximum rates of chlorine production achieved for experiments run as packed and fluidized bed reactions where all other parameters were the same.

FIG. 9 shows the average and maximum rates of chlorine production achieved for experiments run with different amounts of catalyst where all other parameters were the same and oxygen flow was the minimum required for fluidization for each bed size.

FIG. 10 shows the measured moles of chlorine dissolved into the solution and the estimated total chlorine produced based on a 7% solubility of chlorine gas in water.

### DETAILED DESCRIPTION

Examples of the materials, systems, methods and apparatuses discussed herein are not limited in application to the details of construction and the arrangement of components set forth in the following description or illustrated in the accompanying drawings. The systems, methods and apparatuses are capable of implementation in other examples and of being practiced or of being carried out in various ways. Examples of specific implementations are provided herein for illustrative purposes only and are not intended to be limiting. In particular, functions, components, elements, and features discussed in connection with any one or more examples are not intended to be excluded from a similar role in any other examples.

Examples disclosed herein may be combined with other examples in any manner consistent with at least one of the principles disclosed herein, and references to “an example,” “some examples,” “an alternate example,” “various examples,” “one example” or the like are not necessarily mutually exclusive and are intended to indicate that a particular feature, structure, or characteristic described may be included in at least one example. The appearances of such terms herein are not necessarily all referring to the same example.

Also, the phraseology and terminology used herein is for the purpose of description and should not be regarded as limiting. Any references to examples, components, elements, acts, or functions of the computer program products, systems and methods herein referred to in the singular may also embrace embodiments including a plurality, and any references in plural to any example, component, element, act, or function herein may also embrace examples including only a singularity. Accordingly, references in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

The present disclosure describes systems and methods for capture and conversion of carbon dioxide (CO₂), such as present in flue gas and/or fermentation off-gas, to commercially desirable chemical products. The disclosed methods include the use of a high salinity solution and ammonia gas for CO₂ capture and conversion to CaCO3, MgCO3, NaHCO₃, KHCO₃, or other similar carbonates or bicarbonates, and NH₄Cl. In some embodiments, the bicarbonates may be further processed and converted into carbonates. In some embodiments, NH₄Cl may be converted to NH₃ and HCl by applying heat. In some alternate embodiments, NH₄Cl may be converted to NH₃ and NaCl, KCl, CaCl₂), or similar products by adding NaOH, KOH, Ca(OH)₂, or similar hydroxides.

The disclosed systems and methods permit regeneration of the CO2 absorbent, which may increase efficiency and minimize the number of byproducts generated.

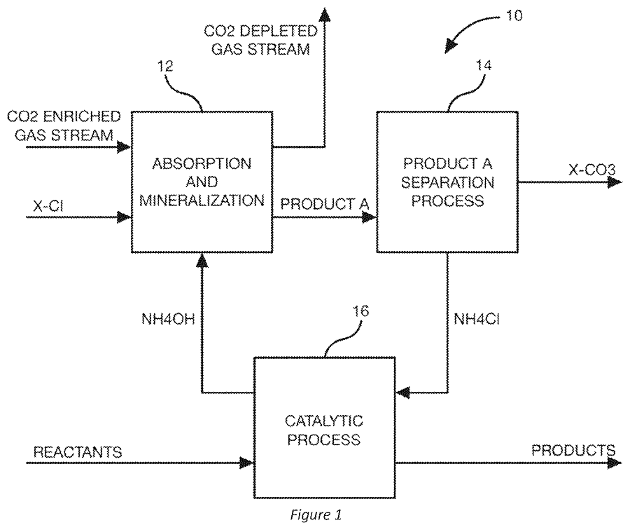

FIG. 1 shows the general process 10 for the conversion of a CO2 enriched gas stream to a CO2 depleted gas stream and commercially valuable chemical products. Process 10 is composed of three key equipment packages/steps: step 12, the absorption and mineralization of CO2 to form X-carbonate and ammonium chloride (“Product A”); step 14, the separation of X-carbonate and ammonium chloride from the mineralization product stream; and step 16, the conversion of ammonium chloride into solvent to be reused in step 12 and products. Note that the numbered boxes in FIG. 1 represent processes and equipment used to conduct the processes. Some of the processes can be combined in one unit or piece of equipment, as would be apparent to a person of ordinary skill in the field.

In some embodiments, the disclosed methods use saline water (aqueous sodium chloride) and ammonia gas for the capture and conversion of CO2, to primary products including sodium carbonate (Na₂CO₃), HCl (or Cl₂), H₂O, and/or NH₄Cl in step 12.

In some embodiments, the disclosed methods use aqueous potassium chloride and ammonia gas for the capture and conversion of CO2 to primary products including potassium carbonate (K₂CO₃), HCl (or Cl₂), H₂O, and/or NH₄Cl in step 12. In embodiments where flue gas is captured and converted, additional products from step 12 may include KNO₃, KNO₂, K₂SO₃, KHSO₃, KHSO₄, and K₂SO₄.

In some embodiments, the disclosed methods use saline water (aqueous sodium chloride) and ammonia gas for the capture and conversion of CO2 to primary products including sodium bicarbonate (NaHCO₃), HCl (or Cl₂), H₂O, and/or NH₄Cl in step 12. In some embodiments, the disclosed methods use aqueous potassium chloride and ammonia gas for the capture and conversion of CO2 to primary products including potassium bicarbonate (KHCO₃), HCl (or Cl₂), H₂O, and/or NH₄Cl in step 12.

In some embodiments, the disclosed methods use aqueous calcium chloride and ammonia gas for the capture and conversion of CO₂ to primary products including calcium carbonate (CaCO₃), HCl (or Cl₂), H₂O, and/or NH₄Cl in step 12.

In some embodiments, sodium bicarbonate, potassium bicarbonate, calcium carbonate, or similar carbonates or bicarbonates generated in step 12 using the disclosed methods are separated from aqueous ammonium chloride in step 14.

In some embodiments, sodium or potassium bicarbonate generated in step 12 using the disclosed methods is heated and converted to sodium or potassium carbonate, respectively.

In some embodiments, ammonium chloride generated in step 12 using the disclosed methods is separated from the solution in step 14 and is converted into hydrochloric acid and ammonia. The resulting mixture of hydrochloric acid and ammonia gases is separated in step 16, and the ammonia is recycled for reuse in the disclosed methods.

With respect to process 10 illustrated in FIG. 1, in some embodiments, the inputs into step 12 are a carbon dioxide-containing gas stream, an absorbent (e.g., NH₄OH), and a high salinity solution (X—Cl). Additionally, gases used for any separation processes used in steps 14 and 16, including the Reactants, are also inputted. In some embodiments, the gases used for the separation processes may be N₂ and O₂. In some embodiments, the gases used for the separation processes may be CO and O₂. The output of the process are carbonate and/or bicarbonate salts such as sodium bicarbonate and calcium carbonate (X—CO3), chlorine (Cl₂), water, N₂, and O₂. In some embodiments, the products may include hydrochloric acid (HCl). In some embodiments, the products may include phosgene (COCl₂).

In some embodiments, a salt is mixed with water in a salt dissolver (not shown) to produce a high salinity solution. The high salinity solution may alternatively be referred to herein as a brine solution or brine. The salt may be pure NaCl, CaCl₂), KCl, or MgCl₂, or a mixture of these salts. In some embodiments, calcium chloride may be added to the salt dissolver in one of three forms: anhydrous CaCl₂, CaCl₂)*2H₂O, or CaCl₂*4H₂O. In some embodiments, magnesium chloride may be added to the salt dissolver in one of two forms: anhydrous MgCl₂ or MgCl₂*6H₂O. In some embodiments, an output of the process is a saturated solution of the salt at the operating temperature. In some embodiments, the salt dissolver is configured to operate at a broad temperature range of 15-70° C., with a preferred operating temperature range of 25-60° C.

In some embodiments, seawater or brackish water may be used as a medium in the salt dissolver. Thus, the disclosed methods may be used in water desalination or water treatment processes, as fresh water is a product generated by use of the disclosed methods.

Prior to treating the carbon dioxide-containing gas stream, the temperature of the gas stream may be lowered by transferring the heat to other process units. For example, in some embodiments, the heat may be transferred to the catalytic process, step 16, that produces NH₄OH and Cl₂. After the gas stream temperature is lowered, the gas stream enters the absorption and mineralization process, step 12.

In some embodiments, the components interacting in step 12 are a carbon dioxide containing gas stream, NH₄OH, and a high salinity aqueous solution that may contain NaCl, CaCl₂), KCl, or a mixture of these salts. In some embodiments, high salinity aqueous solution that may contain NaCl, CaCl₂), KCl, or a mixture of these salts is produced in a mixer where these salts are mixed in water in a continuous stirred reactor. In some embodiments, high salinity aqueous solution and ammonia are mixed in an ammonia absorber to produce an ammoniated solution, and the ammoniated brine solution then flows within a CO₂ absorber (step 12) from the top of the column downward against a CO₂ enriched stream of gas that enters from bottom of the column. The overall reaction between a high salinity solution, ammonium hydroxide, and CO₂ for conversion to NaHCO₃, KHCO₃, CaCO₃, or other similar carbonates or bicarbonates, and NH₄Cl occurs via one or more of the following overall reactions, depending on the composition of the high salinity solution:

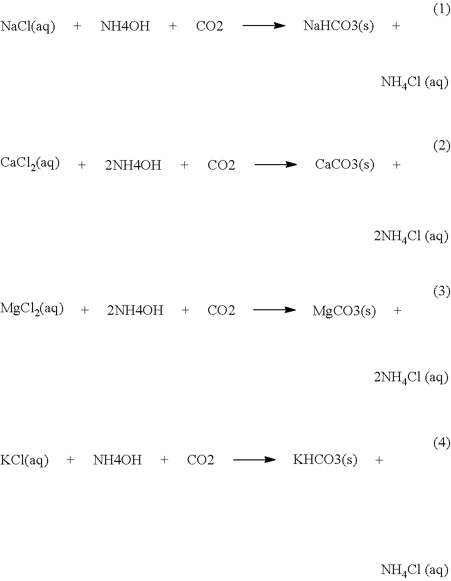

In some embodiments, absorption and mineralization unit, step 12, are configured to operate at a broad temperature range of 10-70° C., with a preferred operating temperature range of 15-60° C. As a result of CO₂ absorption in the absorption and mineralization unit, the amount of CO₂ in the gas stream may be reduced by at least 30% and up to 99%.

In some embodiments, biogas is the gas stream that enters step 12. As a result of the absorption and mineralization, the gas that exits the absorber is a methane enriched gas stream. In some embodiments, the methane enriched gas stream can be commercially used as renewable natural gas (RNG).

The solution that flows from the bottom of the absorber 12 contains aqueous NH₄Cl and carbonate and/or bicarbonate salts (including but not limited to CaCO₃, NaHCO₃, KHCO₃, and MgCO₃) and is directed to a separation process/unit 14. Here the carbonate and/or bicarbonate salts are separated, and aqueous NH₄Cl is transferred to a heater (regenerator) in catalytic process/unit 16. In some embodiments, a weight percent of solid carbonate and/or bicarbonate salts between 10% and 50% exits the carbon dioxide absorber in step 12 and enters a solid-liquid separator in step 14. In some embodiments, the solid-liquid separator in step 14 consists of or includes a filter or centrifuge.

In step 14, the ammonium chloride in the aqueous solution that remains after the solid-liquid separation of solid carbonate and/or bicarbonate salts is separated by another separation unit. In some embodiments, this separator may be a crystallizer or an evaporator. In some embodiments, a single unit may separate both the carbonate and/or bicarbonate salt and ammonium chloride from the product produced by step 12. The NH₄Cl enriched stream that leaves step 14 then enters the catalytic process, step 16.

In the catalytic process, step 16, the NH₄Cl in the enriched stream decomposes at elevated temperature to NH₃ and HCl via the following overall reactions:

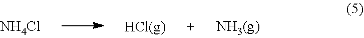

In some embodiments, in step 16, NH₃ is recovered through a catalytic regeneration process, a membrane process, or another separation method. In some embodiments, the catalytic regeneration process is used to recover NH₃ from the stream by reacting hydrochloric acid (HCl) with a catalyst (X) and Oxygen via the following reactions (ammonia recovery step):

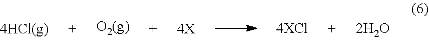

In some embodiments the catalyst (X) used in the catalytic process may be a metal chloride, such as nickel chloride, cobalt chloride, CuCl, or FeCl₂.

In some embodiments the catalyst (X) used in the catalytic process may be molten alkali metal chlorides such as KCl, NaCl, CuCl, KiCl₂ mixed with metal oxide such as Fe, Ni, Co and Cu as disclosed in U.S. Pat. No. 3,627,471 (A).

In some embodiments the catalyst (X) used in the catalytic process may be an activated form of a mixture consisting of a sesquioxide of a metal selected from the class consisting of Mn, Fe, Co, Cu, and Ni, potassium chloride and cuprous chloride, as disclosed in U.S. Pat. No. 3,410,657.

In some embodiments the catalyst used in the catalytic process may be a Metal Oxide (MO), such as nickel oxide, cobalt oxide or CuO, preferably CuO. as disclosed in U.S. Pat. No. 4,959,202A. In some embodiments, when the metal oxide (such as copper oxide) is used to separate NH₃ from the stream, the reaction will be as following:

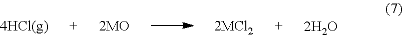

In some embodiments, the catalyst used in the catalytic process is impregnated onto a carrier mass such as alumina, silica or a molecular sieve material as disclosed in U.S. Pat. No. 4,959,202. Impregnation onto these materials provides different surface structures for the catalyst which can affect the reaction rate.

In some embodiments, the ammonia recovery step of the catalytic process is configured to operate at a broad temperature range of 180-450° C., with a preferred operating temperature range of 180-300° C. In some embodiments, the pressure within the ammonia recovery step of the catalytic process may be at least 1 bar and may be up to 20 bar.

In some embodiments, a high temperature inert gas (such as N₂) is used to release the Cl₂ from the catalyst that was used in the ammonia recovery step of the catalytic process and convert it back to its original state via the following reaction (catalyst regeneration step):

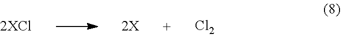

In some embodiments, a metal (M) oxide (such as copper oxide) is used in the ammonia recovery step of the catalytic process to separate NH₃ from the stream, oxygen is used to regenerate the catalyst via the following reaction:

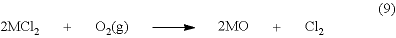

In some embodiments, superheated steam is used in the catalyst regeneration step of the catalytic process to produce hydrochloric acid (HCl) via the following reaction:

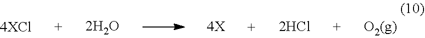

In some embodiments, CO may be used in the catalyst regeneration step of the catalytic process to produce phosgene (COCl₂) via the following reaction:

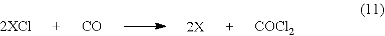

In some embodiments, the catalyst regeneration step of the catalytic process is configured to operate at a broad temperature range of 300-800° C., with a preferred operating temperature range of 300-500° C. In some embodiments, the pressure of the catalyst regeneration step of the catalytic process may be at least 1 bar and may be up to 20 bar.

In some embodiments, two streams exit the catalytic process, an ammonia-containing stream with a molar ratio of ammonia to hydrochloric acid of more than 1 and a chlorine-containing stream with a molar ratio of ammonia to chlorine of less than 2.

In some embodiments, two streams exit the catalytic process, an ammonia-containing stream with a molar ratio of ammonia to hydrochloric acid of more than 1 and a hydrochloric acid-containing stream with a molar ratio of ammonia to hydrochloric acid of less than 1.

In some embodiments, two streams exit the catalytic process, an ammonia-containing stream with a molar ratio of ammonia to hydrochloric acid of more than 1 and a phosgene-containing stream with a molar ratio of ammonia to phosgene of less than 1.

In some embodiments, the ammonia containing stream exiting the catalytic process is dissolved in the water to produce the fresh solvent (NH₄OH) for the absorption and mineralization step via the following reaction:

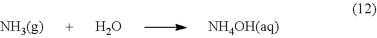

In some embodiments, prior to recycling the ammonia containing stream that leaves the catalytic process, the temperature of the gas stream may be lowered by transferring the heat to other process units. For example, in some embodiments, the heat may be transferred back to the catalytic process to produce NH₄OH and Cl₂. After the gas stream temperature is lowered, the gas stream enters an ammoniation reactor to complete the catalytic process and finish regenerating the solvent.

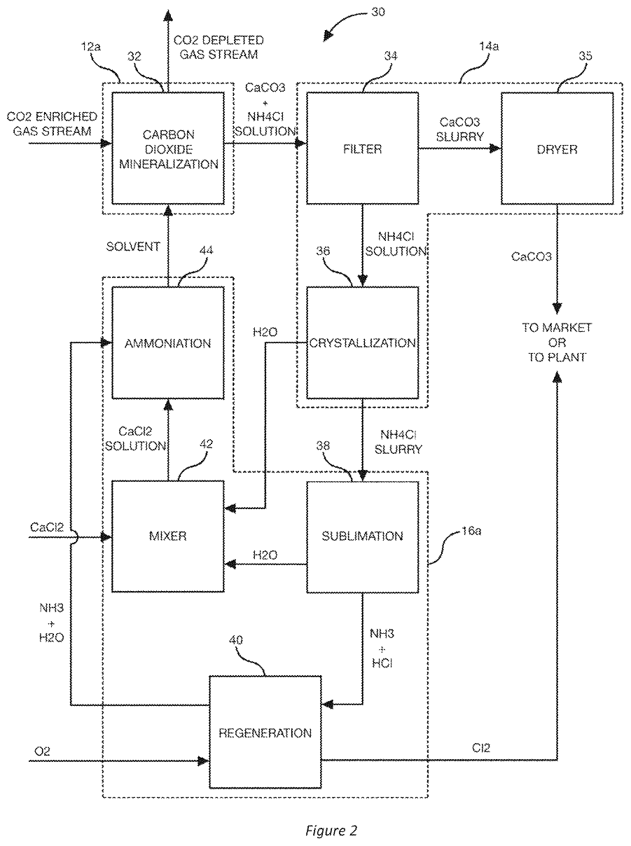

FIG. 2. shows a non-limiting example of a process 30 that is a more detailed example of the process illustrated in FIG. 1. Absorption and mineralization unit 12a includes mineralization/mineralizer 32 the wherein the CO2 enriched gas stream (such as flue gas or fermentation off-gas) comes in contact with a solvent (NH₄OH mixed with CaCl2) producing CaCO3, NH4Cl and CO2 depleted gas. The CO2 depleted gas then flows out and leaves the process entirely. After leaving the step 32, CaCO3 in the form of solid is physically separated from aqueous solution of ammonium chloride using a physical separation process such as filtration, step 34. The output CaCO3 slurry can be dried using dryer 35 as needed before it is used further, such as sold to an industrial market or used in a different process. The stream output of separation step/filter 34 is a solution of ammonium chloride which is fed to a crystallizer 36. The output of the crystallizer would be the more concentrated solution of ammonium chloride (NH4Cl slurry) and water (with some residual salts). Water is fed to mixer 42. Separation process/unit 14a includes filter 34, crystallizer 36 and optional dryer 35.

The slurry from crystallizer 36 is heated in sublimation unit/step 38, to 200-350C to sublimate the ammonium chloride into ammonia (NH3) and hydrochloric acid (HCl). Unit 38 includes a condenser to condense the water vapor created by the heater. The condensed water is sent to unit 42. In step/regenerator 40, the hydrochloric acid reacts with catalyst in presence of oxygen to release ammonia. The recovered ammonia in the form of a gas then flows out and leaves the regeneration unit. The catalyst is heated to 400-500 C to produce chlorine. The water from step 36 and from step 38 is mixed with CaCl2 salt in mixer/step 42 to produce an aqueous solution of CaCl2. The ammonia released from step 40 is then mixed with the aqueous solution of CaCl2 (output of step 42) in an ammoniation unit (step 44) to produce fresh solvent for the absorption and mineralization process (step 32). Catalytic process 16a includes sublimation 38, regeneration 40, mixer 42, and ammoniation 44.

Note that the numbered boxes in FIG. 2 represent processes and equipment used to conduct the processes. Some of the processes can be combined in one unit or piece of equipment, as would be apparent to a person of ordinary skill in the field.

### EXAMPLES

### Example 1: Mineralization

The first parameter that was tested was the effect of solvent composition. This was tested by performing mineralizations in a three-inch diameter and 36 inch tall PVC column with different solvents. For each mineralization, the column was packed with ceramic pellets to aid in distributing the gas and liquid flow throughout the column, the carbon dioxide rich feed was introduced to the column via a bubbler at the bottom of the reactor. Additionally, the solvent was added at the top of the column and allowed to flow to an outlet at the bottom. The configuration was run in a semi batch mode where solvent was continually recycled while fresh carbon dioxide was fed to the column. The entire experiment occurred at room temperature and conversion was tracked using pH. The mineralization ran until the pH stopped changing or started to increase. Calibration samples were made to determine the pH at different conversions of calcium chloride.

It was found that the desired concentrations of calcium chloride (CaCl2) and ammonium hydroxide (NH₄OH) in the solvent were 2.51 and 10.56 molal respectively (a stoichiometric excess of NH₄OH of 110%). However, when the concentration of each was decreased by a factor of 10 individually, 2.51 molal CaCl2 with 1.06 molal NH₄OH (374% stoichiometric excess CaCl2) and 0.251 molal CaCl2 with 10.56 molal NH₄OH (1,995% stoichiometric excess NH₃), additional undesirable products formed. This was determined by developing pH calibration curves using samples based on the expected conversion of the limiting reagent. For both the excess calcium chloride and ammonium hydroxide, samples reached estimated conversions of 190% and 135% respectively, signaling that additional products were formed which further changed the pH. Table 1 presents the expected starting pH, expected pH at 100% conversion, actual starting pH, and actual final pH for each composition that was tested and shows that the standard solvent composition remained within the expected pH range while both solvents with significant stoichiometric excess had final pH's beyond the expected range.

TABLE 1
Comparison of expected and actual pH values
for different solvent compositions.

| | Expected | Expected pH | Actual | Actual |
|---|---|---|---|---|
| | Starting | at 100% | Starting | Ending |
| Sample | pH | Conversion | pH | pH |
| Standard | 11.04 | 7.63 | 11.09 | 8.63 |
| Excess CaCl2 | 10.32 | 6.79 | 10.25 | 3.95 |
| Excess NH4OH | 12.35 | 10.85 | 12.27 | 10.01 |

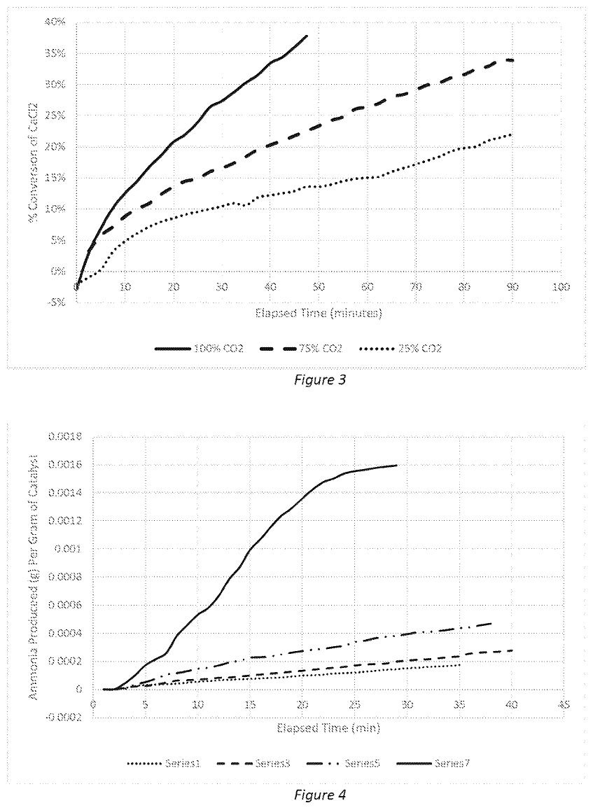

Another potential effect that was investigated was the effect of carbon dioxide concentration in the feed. Compositions of 100%, 75%, and 25% carbon dioxide by volume were tested and it was found that as the concentration of carbon dioxide decreased with total flow remaining constant, the rate of calcium carbonate production decreased. This was expected since the lower concentration means slower flow of carbon dioxide into the mineralization column. FIG. 3 compares the rate of calcium carbonate production at each flue gas concentration. Carbon Hydrogen Nitrogen (CHN) elemental analysis was used to analyze the composition of the mineralization products and it was found that the concentration of carbon dioxide in the feed did not influence the purity of the calcium carbonate that was produced. Table 2 displays the purity of the calcium carbonate produced by each flue gas concentration. The slight variation in the purity of the samples is due to small inconsistencies in the washing of the samples.

TABLE 2
Calcium carbonate purity for different
volume compositions of carbon dioxide.

| | Calcium | Percent |
|---|---|---|
| Carbon Dioxide | Carbonate | of CO2 |
| Concentration | Purity | Captured |
| 100% | 97.8% | 99.4% |
| 75% | 98.0% | 97.2% |
| 25% | 99.1% | 97.1% |

### Example 2: Crystallization

Due to the lower solubility of ammonium chloride in water than calcium chloride, crystallization can be used to supersaturate ammonium chloride in the solution while calcium chloride remains unsaturated in the solution. Once ammonium chloride is supersaturated it forms solid crystals which can be easily separated from the spent solvent and sent to the regeneration unit.

To verify this hypothesis, a bench scale forced circulation crystallizer was constructed. The solution was introduced to the crystallizer below the liquid surface in an upward direction, the solid crystal rich flow then left the bottom of the crystallizer into an open reservoir. The solution in the reservoir was then pumped through a boiling water heat exchanger and back into the crystallizer. The crystallizer ran at different heat exchanger temperatures for one hour at each temperature. After visible crystal formation began, that run was finished and the final solution was collected and crystals were separated via centrifugation.

After the crystallization process, salt crystals had formed on the surfaces near the outlet and the remaining solution was centrifuged to remove any remaining suspended crystals. The liquid samples were then analyzed using ion chromatography (IC) to determine the concentration of any ammonium, calcium, and chloride ions. The IC results supported the hypothesis and are presented in Table 3. After crystallization, the sample had decreased ammonium concentration which confirms that the ammonium formed solid crystals which were removed. The calcium concentration, however, increased because of the decrease in the volume of the solvent (the crystallization process evaporates the solvent).

TABLE 3
Concentration of ammonium and calcium chloride in
the solvent before and after crystallization.

| | Initial | Final |
|---|---|---|
| | Concentration | Concentration |
| | (mM) | (mM) |
| Calcium Chloride | 137.3 | 284.2 |
| Ammonium Chloride | 753.7 | 553.1 |

By accounting for the loss of solvent due to evaporation, the molar amount of calcium chloride and ammonium chloride present in the sample before and after crystallization can be found. Table 4 shows that the amount of calcium chloride in the sample remained constant (percent change of 0.4%) during the crystallization while the amount of ammonium chloride decreased by 65.7%. This confirms that the ammonium chloride crystallized, forming solid crystals, while the calcium chloride remained dissolved in the solvent. These solid crystals are then collected via a filtration with an ammonium chloride recovery of 65.7%.

TABLE 4
Millimoles of ammonium and calcium chloride in
the solvent before and after crystallization.

| | Initial Amount | Final Concentration |
|---|---|---|
| | (mmol) | (mmol) |
| Calcium Chloride | 127.0 | 126.5 |
| Ammonium Chloride | 697.2 | 246.1 |

### Example 3: Solvent Regeneration

There are a variety of different parameters that could influence the solvent regeneration step. The following were investigated through experimentation: the effect of temperature, bed orientation, and salt phase when fed. These effects were investigated using two experimental apparatuses. The first apparatus was a packed bed reactor where catalyst impregnated alumina beads were packed into a reactor and ammonium chloride salt was placed in the middle of the reactor. The reactor was then heated to various temperatures while oxygen gas was flown through the reactor. The second apparatus was a fluidized bed apparatus where pure catalyst and salt were mixed and fluidized within a column, this column was heated to the same temperatures as the packed bed and the fluidizing gas was oxygen. For both runs, the ammonia production was measured by dissolving the ammonia gas that was produced in water and monitoring the change in pH until the pH stopped changing with time or started to decrease.

The effect of temperature was tested at temperatures varying between 190° C. and 240° C. in a packed bed. It was found that as the temperature increased, so did the rate of ammonia production. The rates of production for 190° C., 210° C., 230° C., and 240° C. are displayed in FIG. 4 and Table 4. Minimal performance improvements were observed between 190° C., 210° C., and 230° C. but both the average and maximum instantaneous rates increased by a factor of 10 when the temperature was raised from 230° C. to 240° C. This increase in efficiency is believed to be due to a significant increase in the rate of sublimation of ammonium chloride between 230° C. and 240° C. This increased rate of sublimation greatly increases the amount of hydrochloric acid available to react with the catalyst.

TABLE 5
Average and maximum instantaneous ammonia
production rates at different temperatures

| | Average Rate (g/min) | Maximum Rate (g/min) |
|---|---|---|
| 190° C. | 0.000025 | 0.000065 |
| 210° C. | 0.000055 | 0.000157 |
| 230° C. | 0.000100 | 0.000272 |
| 240° C. | 0.001083 | 0.003110 |

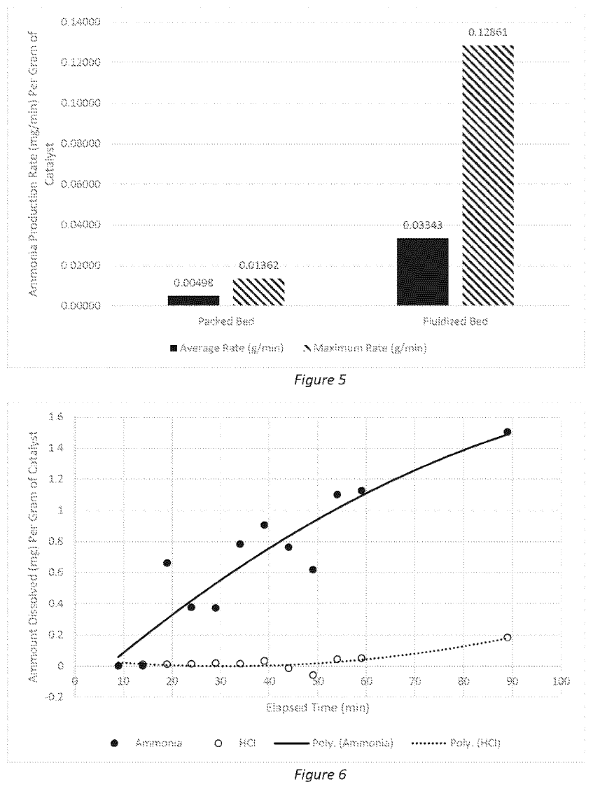

The solvent regeneration was also tested in a fluidized bed using pure cuprous chloride as a catalyst. When compared to the packed bed rate at the same temperature, the fluidized bed had an average rate that was double that of the packed bed and a maximum rate that was triple. The comparison of these two experiments is shown in FIG. 5. Ion chromatography was used to analyze the samples collected during a fluidized solvent regeneration to verify the presence of the expected ions in the solution. FIG. 6 shows that the amount of ammonia in the solution increased over time while the amount of chlorine stayed constant. This verifies that during the solvent regeneration step, chlorine is captured by the catalyst while ammonia passes through the reactor. The slight increase in the amount of hydrochloric acid dissolved at the end of the experiment signaled that at 90 minutes the amount of fresh catalyst was lower than the amount of hydrochloric acid being produced, and thus the catalyst needed to be regenerated.

### Example 4: Catalyst Regeneration

Copper (ii) chloride can then thermally decompose to form cuprous chloride (the original catalyst) and chlorine gas (an overall process product). The rate of this thermal decomposition is affected by a variety of factors. The different factors that were tested experimentally were temperature, fluidization, bed size, grind size, and pre drying. The same two apparatuses that were used to test the solvent regeneration were used to test the catalyst regeneration: a packed bed and a fluidized bed. The key differences were the increased operating temperature which started at 400° C. and a lack of ammonium chloride salt. For the packed bed, the catalyst was impregnated onto alumina beads and was held at various temperatures while oxygen was flowed through the column. For the fluidized bed, pure catalyst was fluidized in the column with oxygen and was held at various temperatures. For both runs, the chlorine production was measured by dissolving the chlorine in water and monitoring the change in pH until the pH stopped changing with time or started to increase.

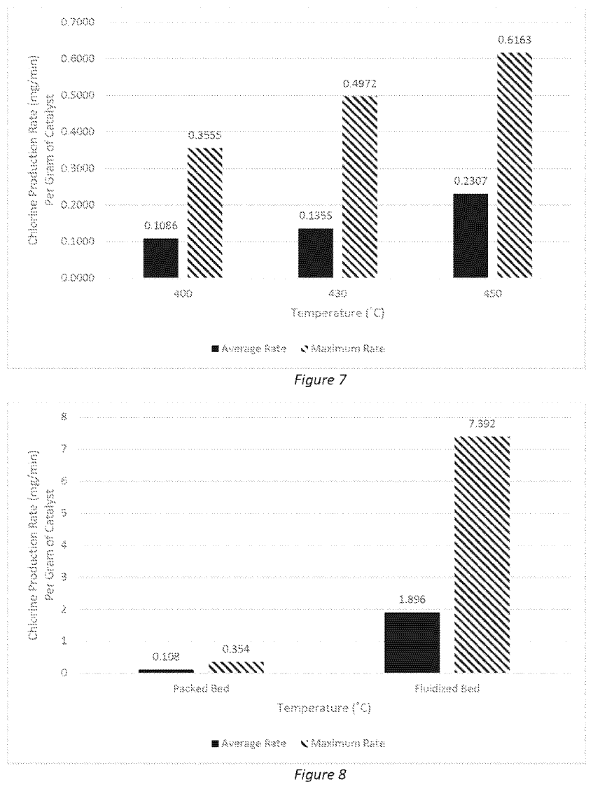

Since the regeneration of the catalyst is achieved via thermal decomposition, the temperature is the controlling parameter. The regeneration was performed at a variety of temperatures ranging from 400° C. to 450° C. using a simple packed bed. It was found that while the reaction occurred at the lowest temperature of 400° C., it increased in efficiency as the temperature increased. FIG. 7 compares the average and maximum rates for the catalyst regeneration experiments that were done at 400° C., 430° C., and 450° C.

It was also found that fluidizing the system increased the rate of chlorine production. This is due to two factors. First, the fluidized system uses smaller pieces of catalyst, increasing the surface area of the catalyst in the bed. Additionally, the fluidization itself improves the mixing and increases the interactions between the catalyst and the heated walls of the reactor. These improvements led to an increase in chlorine production by roughly a factor of 10. Under the same conditions (using oxygen to fluidize at a temperature of 400° C.) the packed bed system had an average rate of chlorine production of 0.108 mg/min per gram of catalyst and a maximum rate of 0.354 mg/min per gram of catalyst while the fluidized bed system had an average rate of 1.896 mg/min per gram of catalyst and a maximum rate of 7.392 mg/min per gram of catalyst. A visual comparison of these values is displayed in FIG. 8.

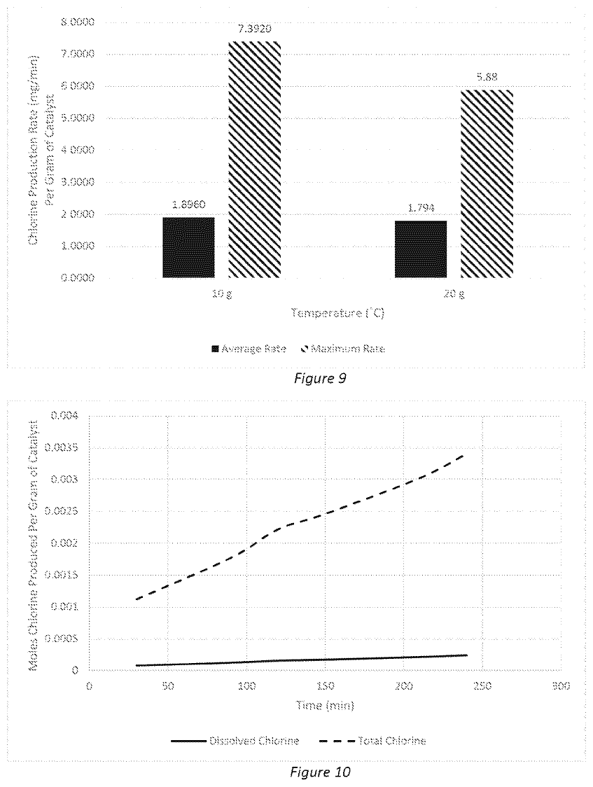

Once it was determined that the fluidized system could produce chlorine at a higher rate using the same size reactor, the maximum amount of catalyst that could be used in a single regeneration was tested. To test this, the initial amount of catalyst was doubled from 10 g to 20 g and the oxygen flowrate was increased to account for the added mass that required fluidization. It was found that doubling the initial amount of catalyst had little effect on the average rate of chlorine production per gram of catalyst (from 1.896 mg/min to 1.794 g/min) and decreased the maximum rate of production per gram of catalyst by roughly 20% (from 7.392 mg/min to 5.880 mg/min). FIG. 9 compares the average and maximum rates for both initial catalyst masses. This comparison shows that increasing the mass of the catalyst results in a slight decrease of the rate of chlorine production per gram of catalyst.

Having described above several aspects of at least one example, it is to be appreciated that various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A system for reducing the amount of carbon dioxide contained in a gas stream, comprising:
a carbon dioxide absorption and mineralization package configured to create at least one of carbonates and bicarbonates, and ammonium chloride, from carbon dioxide in the gas stream, an ammoniated solvent, and at least one metal chloride;
a mineral separation package configured to separate carbonates and bicarbonates from the ammonium chloride; and
a solvent regeneration package configured to use a catalyst in the creation of chlorine and ammonium hydroxide from the ammonium chloride, heat and oxygen.

2. The system of claim 1, wherein the solvent regeneration package is configured to separate HCl from an output of the mineral separation package by reacting HCl with a metal chloride-based catalyst X and oxygen to form XCl and water.

3. The system of claim 2, wherein the solvent regeneration package is configured to regenerate the catalyst X by decomposing XCl in the presence of a high temperature inert gas to generate Cl₂.

4. The system of claim 2, wherein the solvent regeneration package is configured to regenerate the catalyst X by reacting XCl with carbon monoxide to generate phosgene.

5. The system of claim 2, wherein the solvent regeneration package is configured to regenerate the catalyst X by reacting XCl with water to form HCl and oxygen.

6. The system of claim 1, wherein a molar ratio of ammonia to HCl in the solvent regeneration package is more than 1.

7. The system of claim 6, wherein the solvent regeneration package is configured to separate HCl from a gas stream by a membrane separation method.

8. The system of claim 1, further comprising a salt dissolver unit.

9. The system of claim 8, wherein the salt dissolver unit is configured to admix water and a salt to form a high salinity solution that is inputted to the carbon dioxide absorption and mineralization package.

10. The system of claim 9, wherein the high salinity solution is an aqueous solution of CaCl₂, MgCl₂, NaCl, KCl, or a mixture of two or more thereof.

11. The system of claim 8, wherein the salt dissolver unit is configured to admix seawater, brackish water, or wastewater and a salt to form a high salinity solution that is inputted to the carbon dioxide absorption and mineralization package.

12. The system of claim 11, wherein the high salinity solution is an aqueous solution of CaCl₂, MgCl₂, NaCl, KCl, or a mixture of two or more thereof.

13. The system of claim 11:
wherein the solvent regeneration package comprises an ammonia absorber configured to admix ammonia from the separator package with the high salinity solution to form an ammoniated high salinity solution;
wherein the carbon dioxide absorption and mineralization package is configured to admix the ammoniated high salinity solution from the ammonia absorber and a carbon dioxide containing gas stream to form aqueous ammonium chloride and carbonate and/or bicarbonate salts;
wherein the mineral separation package comprises a solid-liquid separator configured to separate at least a portion of the carbonate and/or bicarbonate salts from the aqueous ammonium chloride, wherein the carbonate and/or bicarbonate salts may be hydrated or anhydrous; and
wherein the solvent regeneration package further comprises a heater configured to vaporize water from the aqueous ammonium chloride and decompose ammonium chloride to form a mixture containing ammonia and HCl, and a water condenser configured to condense water vapor generated by use of the heater to generate liquid water.

14. The system of claim 1, wherein the solvent regeneration package comprises an ammonia absorber configured to admix ammonia with a brine solution to form ammoniated brine.

15. The system of claim 14, wherein the carbon dioxide absorption and mineralization package is configured to admix ammoniated brine and a carbon dioxide containing gas stream to form aqueous ammonium chloride and carbonate and/or bicarbonate salts.

16. The system of claim 15, wherein the mineral separation package comprises a solid-liquid separator configured to separate at least a portion of the carbonate and/or bicarbonate salts from the aqueous ammonium chloride, wherein the carbonate and/or bicarbonate salts may be hydrated or anhydrous.

17. The system of claim 16, further comprising a dryer configured to remove at least a portion of water from hydrated carbonate and/or bicarbonate salts that are separated in solid liquid separator.

18. The system of claim 15, wherein the solvent regeneration package further comprises a heater configured to vaporize water from the aqueous ammonium chloride and decompose ammonium chloride to form ammonia and HCl.

19. The system of claim 18, wherein the solvent regeneration package further comprises a water condenser configured to condense water vapor generated by use of the heater.

20. A method for reducing the amount of carbon dioxide contained in a gas stream, comprising:
creating at least one of carbonates and bicarbonates, and ammonium chloride, from carbon dioxide in the gas stream, an ammoniated solvent, and at least one metal chloride;
separating carbonates and bicarbonates from the ammonium chloride; and
using a catalyst in the creation of chlorine and ammonium hydroxide from the ammonium chloride, heat and oxygen.
